(19) United States
(12) Patent Application Publication
(10) Pub. No.: US 2013/0102401 A1
(43) Pub. Date: Apr. 25, 2013

(54) METHOD AND APPARATUS FOR MANUFACTURING A DUAL-THREADED BOLT

(71) Applicant: Nucor Corporation, Charlotte, NC (US)

(72) Inventors: James Wayne Hudson, Harlan, IN (US); Robert Lee Collins, Saint Joe, IN (US)

(73) Assignee: Nucor Corporation, Charlotte, NC (US)

(21) Appl. No.: 13/655,136

(22) Filed: Oct. 18, 2012

Related U.S. Application Data
(60) Provisional application No. 61/550,082, filed on Oct. 21, 2011.

(51) Int. Cl. B23G 1/02; B21H 3/06

(52) U.S. Cl. CPC B23G 1/02; B21H 3/06
USPC 470/11; 72/95; 470/57

(57) ABSTRACT

Embodiments of the present invention comprise methods and apparatuses for manufacturing dual-threaded bolts. The invention comprises utilize rolling dies having one die with coarse thread projections over a surface of the die and fine thread projections over another surface of the die. In some embodiments, the surfaces on which the coarse thread projections and the fine thread projections are located are distinct from one another, or in other embodiments a portion of the surfaces may overlap or be formed integrally within the other projections. In some embodiments a portion of, or all of, the coarse thread projections may be located on a first die section piece while a portion of, or all of, the fine thread projections may be located on separate second die section piece (e.g., an insert) that is operatively coupled to the first die section piece.

### CLAIM OF PRIORITY UNDER 35 U.S.C §119

The present Application for a Patent claims priority to Provisional Application No. 61/550,082, entitled “Method and Apparatus for Manufacturing a Dual-Threaded Bolt,” filed Oct. 21, 2011, and assigned to the assignee hereof and hereby expressly incorporated by reference herein.

### BACKGROUND

Dual-threaded bolts are used in various applications to prevent nut loosening from vibratory or other types of loading. Dual-threaded bolts comprise a bolt with coarse threads and a fine threads overlapping or integral with each other. The coarse threads and the fine threads typically have different pitches, such that the pitch ratio of the coarse threads and the fine threads are not in a one-to-one ratio. During the use of a dual-threaded bolt in an application, a coarse threaded nut is fastened to the dual-threaded bolt through engagement with the coarse threads of the dual-threaded bolt, and a fine threaded nut is fastened to the dual-threaded bolt through engagement with the fine threads of the dual-threaded bolt. Since the coarse threaded nut and the fine threaded nut have different turning rates, due to the differences in the pitches of the coarse threads and the fine threads of the dual-threaded bolt, the coarse threaded nut and the fine threaded nut will not loosen or back off its assembled configuration when subjected to the same vibratory or other loading. The dual-threaded bolt, coarse threaded nut, and fine threaded nut combination create an anti-loosening fastening system for use in various applications.

Dual-threaded bolts have been manufactured a number of ways; however the current methods and the associated dies used to form dual-threaded bolts do not meet acceptable tolerances requirements and/or are too expensive to produce. Methods of forming dual-threaded bolts with tight tolerances at lower costs are desired.

### BREIF SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the present invention utilize rolling dies having at least one die with coarse thread projections over a surface of the die and fine thread projections over another surface of the die. In some embodiments, the surfaces on which the coarse thread projections and the fine thread projections are located are distinct from one another, or in other embodiments a portion of the surfaces may overlap or be formed integrally within the other projections. In some embodiments the threads may be manufactured onto a single die or in other embodiments a portion of, or all of, the coarse thread projections may be located on a first die section piece while a portion of, or all of, the fine thread projections may be located on separate second die section piece (e.g., an insert) that is operatively coupled to the first die section piece. The present invention is described herein with respect to flat dies, but may also be configured as cylindrical dies.

In one embodiment of the invention a pair of opposing flat dies is utilized in a rolling apparatus to form a dual-threaded bolt. In one embodiment, the pair of opposing flat dies comprises a first flat die having both coarse and fine thread projections located in series on the die. Specifically, in one embodiment, from left to right on the face surface of the die, the coarse thread projections are located on the left side of the face of the die followed by the fine thread projections. In some embodiments, the first die comprises two sections, a first section that comprises the coarse thread projections and a second section that comprises the fine thread projections located to the right of the coarse thread projections on the face of the surface of the die. In some embodiments, the transition from the first section to the second section may comprise fine thread leading edge projections that are formed over or integrally with a portion of the coarse thread projections. The fine thread leading edge projections may provide for a smooth transition when a bolt is rolled from the first section with the coarse thread projections to the second section with the fine thread projections.

In some embodiments of the invention, the first section of the die includes an extending portion (e.g. leg) that extends from left to right at the top of the die with the second section residing below the extending portion (e.g. leg). In some embodiments, the second section of the die containing the fine thread projections is an insert for the first section of the die. Therefore, the first section of the die with coarse thread projections is configured for being operatively coupled to the second section with the fine thread projections. Thus, in one embodiment of the invention an opposing die set comprises a first flat die with coarse thread projections, which is adapted to receive an insert having fine thread projections, and an second flat die with coarse threaded projections. The first flat die and second flat die can be manufactured utilizing mills, electronic discharge machining, or other thread projection forming operations.

The first and second dies are assembled in a rolling apparatus used to form threads on a bolt. In one embodiment the first flat die with coarse thread projections and the insert with fine thread projections are connected to the die rolling machine as a stationary die, and the second flat die with coarse thread projections is connected to the die rolling machine as a moving die. A bolt shank is placed in-between the opposing dies. The moving die is actuated and the shank is rolled between the surfaces of the dies that comprise the coarse thread projections, such that coarse threads are formed on the shank of the bolt. As the dies move relative to one another, the bolt passes from the surface of the stationary die having coarse thread projections to the insert of the stationary die having the fine thread projections. The fine thread projections of the stationary die will form the fine threads on the coarse threads that were previously formed on the bolt shank, while at the same time the coarse thread projections of the moving die hold the bolt shank in the proper vertical alignment as it is rotated across the stationary die insert to form the fine threads.

One embodiment of the invention is a method for manufacturing a dual-threaded rod comprising forming a coarse thread over a first portion of a rod using a rolling apparatus in a single rolling pass; forming a fine thread on the coarse thread over the first portion of the rod using the rolling apparatus in the single rolling pass; and wherein the rolling apparatus comprises a first die with coarse thread projections and fine thread projections, and a second die with coarse thread projections.

In further accord with an embodiment of the invention, the first die comprises a coarse thread section with the coarse thread projections operatively coupled to a fine thread section with the fine thread projections.

In another embodiment of the invention, the fine thread section is an insert and the coarse thread section is configured to be operatively coupled to the insert.

In yet another embodiment of the invention, the coarse thread section comprises an extending section, wherein the extending section forms a coarse thread over a second portion of the rod that does not have fine threads.

In still another embodiment of the invention, the coarse thread projections and the fine thread projections of the first die are located on separate surfaces of a face of the first die.

In further accord with an embodiment of the invention, the rod is a bolt. In another embodiment of the invention, the first die is a stationary die. In yet another embodiment of the invention, the second die is a moveable die.

In still another embodiment of the invention, forming the coarse thread and forming the fine thread in the single pass is accomplished by actuating the second die relative to the first die.

In further accord with an embodiment of the invention, at a transition from the coarse thread projections to the fine thread projections an edge of the coarse thread projections has integrally formed fine thread projections.

In another embodiment of the invention, at a transition from the coarse thread projections to the fine thread projections an edge of the fine thread projections has integrally formed coarse thread projections.

Another embodiment of the invention is an apparatus for manufacturing a dual-threaded bolt comprising a first die with coarse thread projections and fine thread projections; a second die with coarse thread projections; wherein the first die and the second die are utilized for forming a coarse thread over a first portion of a rod in a single rolling pass; and wherein the first die and the second die are utilized for forming a fine thread on the coarse thread over the first portion of the rod using the rolling apparatus in the single rolling pass.

In further accord with an embodiment of the invention, the first die comprises a coarse thread section with the coarse thread projections operatively coupled to a fine thread section with the fine thread projections.

In another embodiment of the invention, the fine thread section is an insert and the coarse thread section is configured to be operatively coupled to the insert.

In yet another embodiment of the invention, the coarse thread section comprises an extending section, wherein the extending section forms a coarse thread over a second portion of the rod that does not have fine threads.

In still another embodiment of the invention, the coarse thread projections and the fine thread projections are located on separate surfaces of a face of the first die.

In further accord with an embodiment of the invention, the rod is a bolt. In another embodiment of the invention, the first die is a stationary die. In yet another embodiment of the invention, the second die is a moveable die.

In still another embodiment of the invention, forming the coarse thread and forming the fine thread is accomplished by actuating the second die relative to the first die.

In further accord with an embodiment of the invention, at a transition from the coarse thread projections to the fine thread projections an edge of the coarse thread projections has integrally formed fine thread projections.

In another embodiment of the invention, at a transition from the coarse thread projections to the fine thread projections an edge of the fine thread projections has integrally formed coarse thread projections.

To the accomplishment of the foregoing and the related ends, the one or more embodiments comprise the features hereinafter fully described and particularly pointed out in the claims. The following description and the annexed drawings set forth details of certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a flow diagram for a process of manufacturing dual-threaded bolts, in accordance with one embodiment of the present invention;

FIG. 2 illustrates a perspective view of a rolling apparatus used in the process of manufacturing dual-threaded bolts, in accordance with one embodiment of the present invention;

FIG. 3 illustrates a perspective view of a die and insert used in the process of manufacturing dual-threaded bolts, in accordance with one embodiment of the present invention;

FIG. 4A illustrates a perspective close-up view of the die and insert from FIG. 3 used in the process of manufacturing dual-threaded bolts, in accordance with one embodiment of the present invention;

FIG. 4B illustrates a perspective close-up view of a die and insert used in the process of manufacturing dual-threaded bolts wherein fine thread projections are formed integrally together with the coarse thread projections of the coarse thread section, in accordance with one embodiment of the present invention;

FIG. 4C illustrates a perspective close-up view of a die and insert used in the process of manufacturing dual-threaded bolts wherein coarse thread projections are formed integrally together with the fine thread projections of the fine thread section, in accordance with one embodiment of the present invention;

FIG. 5 illustrates a perspective view of the die and insert assembled in the rolling apparatus for use in the process of manufacturing dual-threaded bolts, in accordance with one embodiment of the present invention;

FIG. 6 illustrates a perspective view of an opposing die assembled in the rolling apparatus for use in the process of manufacturing dual-threaded bolts, in accordance with one embodiment of the present invention;

FIG. 7 illustrates a perspective view of the rolling apparatus with the bolt shank placed in-between the dies for manufacturing a dual-threaded bolt, in accordance with one embodiment of the present invention;

FIG. 8 illustrates a perspective view of the rolling apparatus with the bolt shank in-between the surfaces of the dies with the coarse thread projections for rolling the coarse thread of the dual-threaded bolt, in accordance with one embodiment of the present invention;

FIG. 9 illustrates a perspective view of the rolling apparatus with the bolt shank in-between the surfaces of the die with the coarse thread projections and the die insert with the fine thread projections, in accordance with one embodiment of the present invention;

FIG. 10 illustrates a perspective view of the rolling apparatus with the bolt shank in-between the surfaces of the dies after the dual-threaded bolt has been formed, in accordance with one embodiment of the present invention; and

FIG. 11 illustrates a side view of an example of the dual-threaded bolt formed from the rolling apparatus, in accordance with one embodiment of the present invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Dual-threaded bolts may be manufactured by rolling a bolt through a die set of two opposing dies. One example of a die set includes one flat die with coarse thread projections and another flat die with fine thread projections. Thus, during the rolling operation the coarse thread die forms the coarse thread on the bolt and the fine thread die forms the fine thread on the bolt. There are a number of issues that may arise with this type of rolling configuration. For example, the tolerances are difficult to control due to a number of factors. Since the coarse threads and the fine threads are formed from opposing dies any misalignment of the dies could reduce the tolerances between the positions of the coarse threads and fine threads of the dual-threaded bolt. Furthermore, the bolt between the die set may not be very stable. As the coarse thread is formed and the bolt surface loses contact with the coarse die and makes contact with the fine die the bolt may not be stable between the dies because the coarse threads are no longer engaged in the projections of the coarse die. While the rolling process utilizing a coarse die and a fine die may be a cost effective method of producing dual-threaded bolts, it may not be efficient enough for producing dual-threaded bolts that require tight tolerances in and between the coarse and fine threads of the bolt.

Rolling a bolt through a die set of two opposing dies may also be performed through the use of cylindrical dies. However, cylindrical dies may be more expensive to manufacture than flat dies, and thus, the dual-threaded bolts produced using the cylindrical dies may be more expensive than using flat dies.

Dual-threaded bolts may also been manufactured utilizing either flat dies or cylindrical dies that have coarse thread projections formed in the die with fine thread projections formed integrally in the coarse thread projections, such that during the rolling process the coarse threads and fine threads are formed at the same time on the surfaces of the bolt that are in contact with the rolling dies. This type of configuration may generally allow for the manufacture of dual-threaded bolts to tighter tolerances than using a pair of separate opposing coarse and fine dies, as discussed above. Alternatively, this type configuration may be more costly than using opposing coarse and fine dies because manufacturing dies having fine thread projections integrally formed in the course thread projections may be more expensive than manufacturing dies with a single thread type.

Dies can be manufactured by cutting the coarse thread projections into the dies using a milling machine, electric discharge machining, or other type of machining or manufacturing process. Manufacturing dies with a single thread (e.g. coarse or fine) only takes one set up process and one cutting process. Manufacturing dies with integral coarse and fine thread projections generally requires two set up processes and two cutting processes. For example, a die with one type of thread can be produced by milling, whereas a die with integral threads may be milled first to form the coarse thread projections, and thereafter, electric discharge machining may be used to form the fine thread projections in the coarse thread projections. Thus, manufacturing dies with dual-integral thread projections over the majority of the surface may be up to twice as expensive, or more, than manufacturing dies with a single type of thread projections.

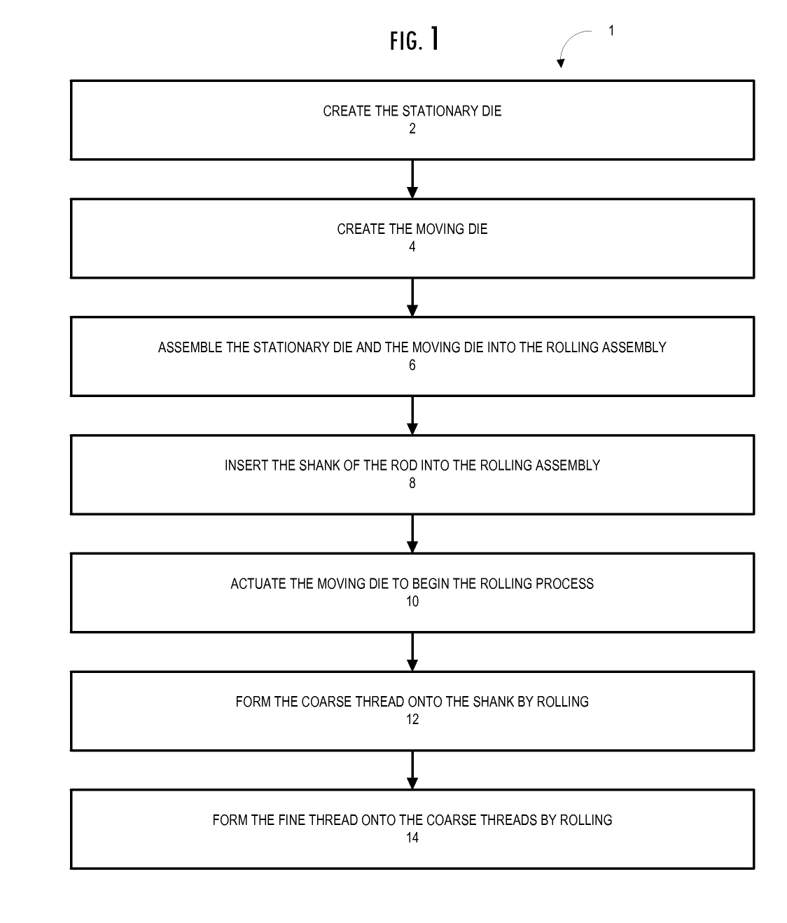

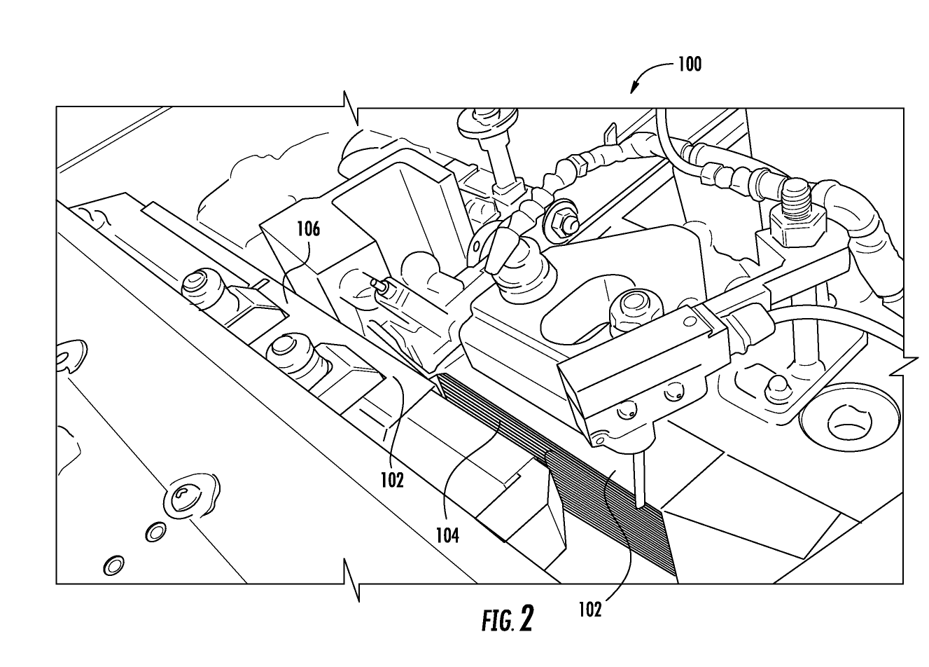

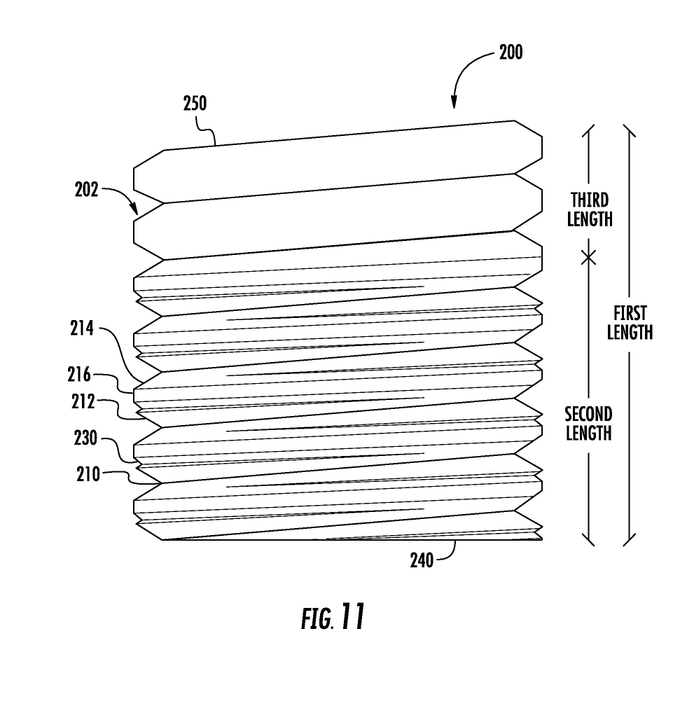

FIG. 1 illustrates a process 1 for manufacturing dual-threaded bolts 200, using a rolling apparatus 100. FIG. 2 illustrates a rolling apparatus 100 that utilizes a pair of opposing flat dies 102, wherein the pair of flat dies 102 comprises a stationary die 104 and a moving die 106. The dual-threaded bolt 200 is formed by inserting the bolt shank 202 between the two opposing dies. The bolt 200 is formed as the moving die 106 is actuated in relation to the stationary die 104, which rotates the bolt 200 between the thread projections of the pair of flat dies 102 to form the threads on the bolt shank 202 (see FIG. 11 illustrating the threaded bolt shank 202). The rolling apparatus 100 described herein is a stationary and movable flat die apparatus; however, the invention described herein may be modified for use in other types of rolling apparatuses that utilize two movable flat dies, two moveable cylindrical dies, or a movable cylindrical die and a stationary die. Thus, in other embodiments of the invention, the rolling apparatus 100 may be an apparatus comprising of two movable flat dies, which move in relation to one another to produce the dual-threaded bolt 200. In still other embodiments of the invention the rolling apparatus 100 may be an apparatus comprising of two cylindrical dies, which rotate in relation to one another to produce the dual-threaded bolt 200.

As illustrated in block 2 of FIG. 1, the process involves creating a stationary die 104. The stationary die 104 in one embodiment is a first die 110 comprising a face surface 120 with coarse thread projections 122 and fine thread projections 124. In some embodiments of the invention the coarse thread projections 122 and the fine thread projections 124 can be formed on a single die face surface 120 at different locations on the face surface 120 with or without overlapping threads (e.g., threads that are formed integrally together). Thus, in some embodiments of the invention the first die 110 is made up of a two separate sections, a coarse thread section 112 and a fine thread section 114. In one embodiment the coarse thread section 112 and the fine thread section 114 are located on a single first die 110, such that as a bolt 200 moves across face surface 120 of the single first die 110 (e.g. from left to right), the face surface 120 transitions from having coarse thread projections 122 over the left face surface 120 to having fine thread projections 124 over at least a portion of the right face surface 120.

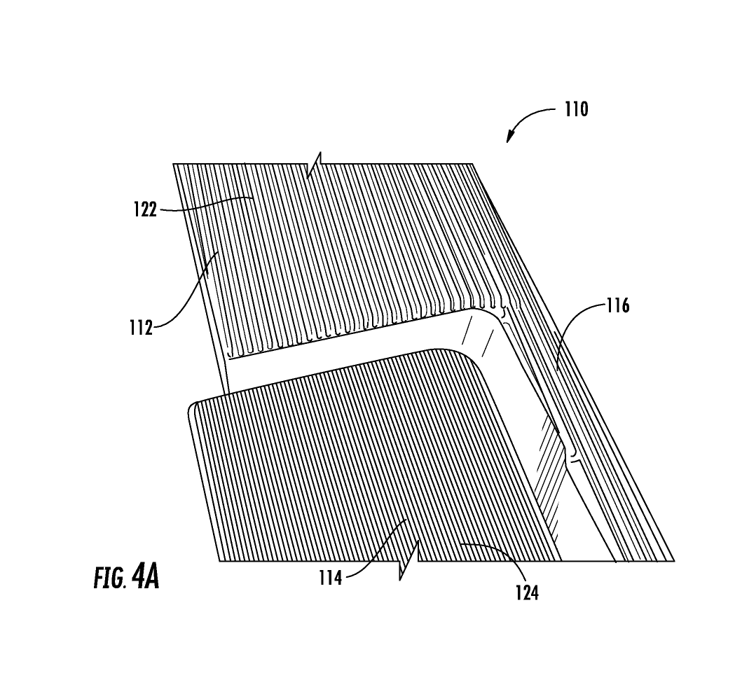

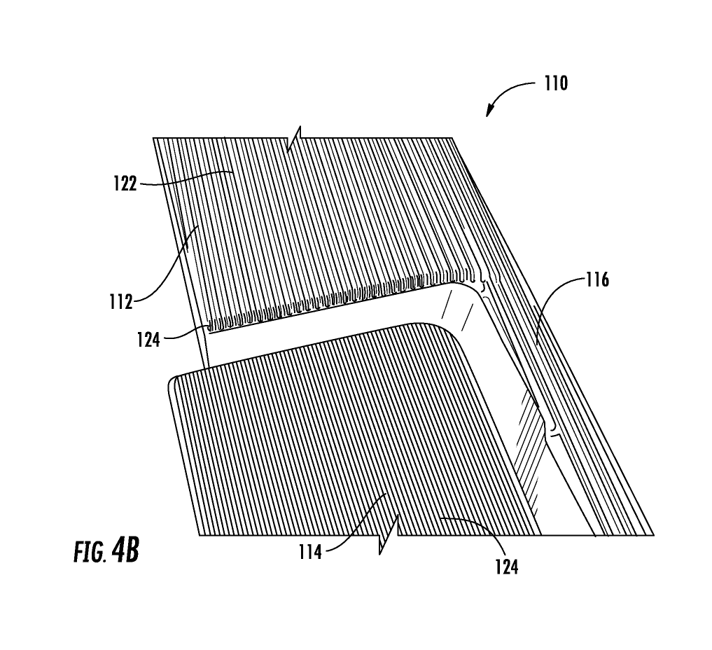

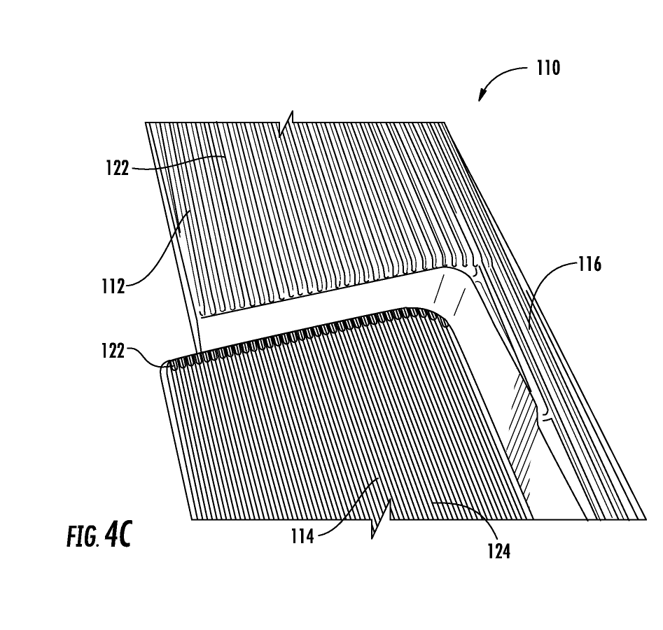

In some embodiments the fine thread projections 124 may overlap and/or be formed integrally within a portion of the coarse thread projections 122, as illustrated in FIG. 4B. Therefore, at the transition from the coarse thread projections 122 to the fine thread projections 124 an edge of the coarse thread projections 122 have integrally formed fine thread projections 124. In other embodiments of the invention the coarse thread projections 122 may overlap and/or be formed integrally within a portion of the fine thread projections 124, as illustrated in FIG. 4C. Therefore, at the transition from the coarse thread projections 122 to the fine thread projections 124 an edge of the fine thread projections 124 have integrally formed coarse thread projections 122. In other embodiments, the fine thread projections 124 may be formed integrally within a portion of the coarse thread projections 122, while the coarse thread projections 124 may be formed integrally within a portion of the fine thread projections 124 (e.g., FIGS. 4B and 4C combined). In these types of embodiments, the transition from the coarse thread projections 122 on the coarse thread section 112 to the fine thread projections 124 on the fine thread section 114 is a smooth transition that reduces potential defects, tolerance issues, and alignment issues of the bolt 200 as the bolt 200 makes the transition from the coarse thread section 112 to the fine thread section 114.

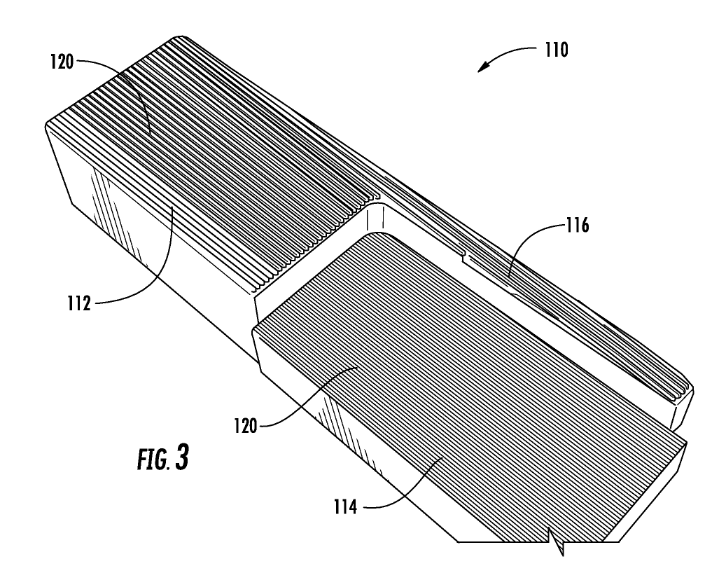

In one embodiment of the invention the coarse thread section 112 and the fine thread section 114 may be separate pieces of the first die 110 that are operatively coupled together. Furthermore, in one embodiment, the fine thread section 114 may be identified as a thread section insert that can be assembled to or within the coarse thread section 112. FIGS. 3 and 4 illustrate one embodiment of the invention wherein the coarse thread section 112 is formed to receive a fine thread section 114 insert.

In some embodiments, as illustrated in FIGS. 3 and 4, the coarse thread section 112 comprises a coarse thread extending section 116 (e.g., leg), which results in a bolt 200 that has a coarse thread along a first length of the bolt 200 and a fine thread along a second length of the bolt, wherein the first length of the bolt 200 is greater than the second length of the bolt, such that a portion of the bolt shank 202 has a third length with just a coarse thread and not a combination of the coarse thread and fine thread, as discussed later with respect to FIG. 11.

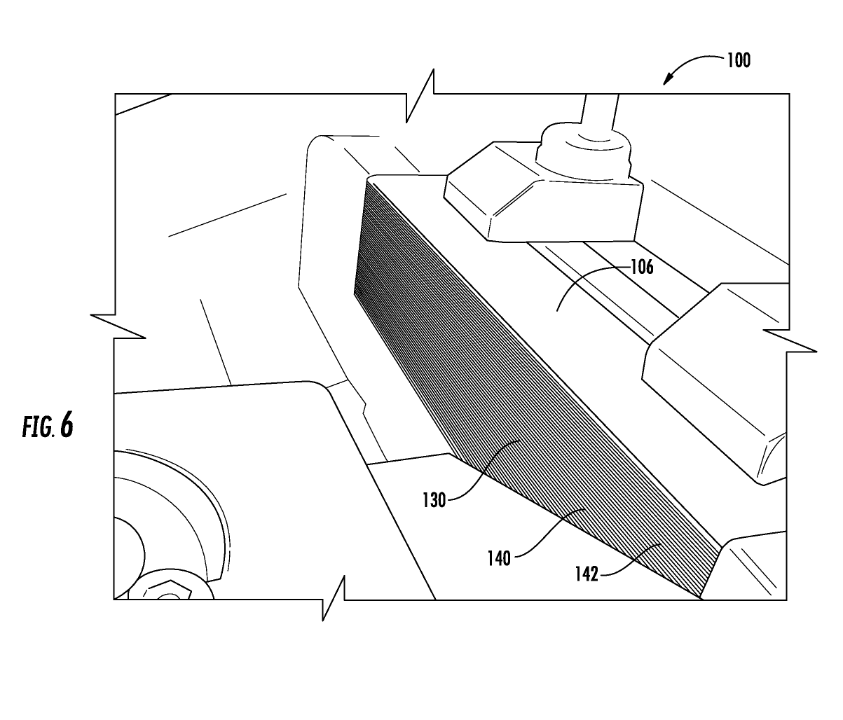

As illustrated in block 4 of FIG. 1, the moving die 104 is created. The moving die 104 in one embodiment, as illustrated in FIG. 6, is a second die 130 that comprises coarse thread projections 142 across at least a portion of the face surface 140. The coarse thread projections 142 on the face surface 140 of the second die 130 may coincide with the coarse thread projections 122 of the face surface 120 of the first die 110, in order to create a coarse thread 210 on the surface of the dual-threaded bolt 200. In some embodiments the coarse thread projections 142 cover the majority, or the entire face surface 140 of the second die 130. Therefore, the second die 130 is responsible for forming at least some of, the coarse threads 210 of the bolt 200, and also, keeps the bolt 200 in the proper orientation when the first die forms the fine threads 230 on the bolt 200. In some embodiments of invention the second die 130 may have similar coarse thread projections 122 and fine thread projections 124 as previously described with respect to the first die 110, such that the second die 130 is also responsible for rolling at least a portion of the fine threads 230 and the coarse threads 210 of the dual-thread bolt 200. Therefore, the second die 130, in some embodiments may comprise coarse thread projections 142 and fine thread projections at different locations on the face surface 140 of a single die with or without overlapping thread projections (e.g., threads that are formed integrally together).

In other embodiments of the invention the second die 130 is made up of two separate sections, a coarse thread section and a fine thread section. In one embodiment the fine thread section may be identified as a thread section insert that can be assembled to or within the coarse thread section, as previously discussed with respect to the first die 110 described above and illustrated in FIGS. 3 and 4. Furthermore, the coarse thread section of the second die 130 may comprise a coarse thread extending section (e.g., leg) which results in a bolt 200 that has a coarse thread along a first length of the bolt 200 and a fine thread along a second length of the bolt 200, wherein the first length of the bolt 200 is greater than the second length of the bolt 200 such that a portion of the bolt shank 202 has a third length with just a coarse thread and not a combination of the coarse thread and fine thread.

In some embodiments of the invention, depending on the type of rolling apparatus 100, the first die 110, which was described as being a stationary die 104, may instead be a moveable die 106, such that the dies 102 in the rolling apparatus 100 are both actuated relative to one another. In some embodiments of the invention, the first die 110, may be the moveable die 106, while the second die 120 may be the stationary die 104. Therefore, in some embodiments of the invention instead of the stationary die 104 having the coarse thread section 112 and the fine thread section 114, the stationary die 104 may have only coarse thread projections, while the moveable die 106 has the coarse thread section 112 and the fine thread section 114.

The dies 102 used in the present invention may be used to produce bolts 200 at a lower cost than bolts produced using dies that have integral coarse thread projections and fine thread projections over some of, a majority of, or the entire die surface. As previously discussed herein creating a die with integral coarse and fine thread projections may require multiple machining set ups and cutting processes (e.g. a first milling process and a second electric discharge machining process, etc.). Alternatively, flat dies 102 described herein only require a single machining process to form either the coarse thread projections or fine thread projections. The dies 102 and associated inserts 114 described herein can be manufactured separately and operatively coupled together in a rolling assembly 100 for forming dual-threaded bolts 200 to tolerances that are the same as or similar to bolts 200 that are formed with dies having integral coarse and fine thread projections over a majority of the surface, but at a lower cost. Furthermore, the dies 102 used in the present invention can be used to produce bolts 200 that have tighter tolerances than bolts 200 produced using opposing dies that only have coarse thread projections or fine thread projections, but at the same or similar costs.

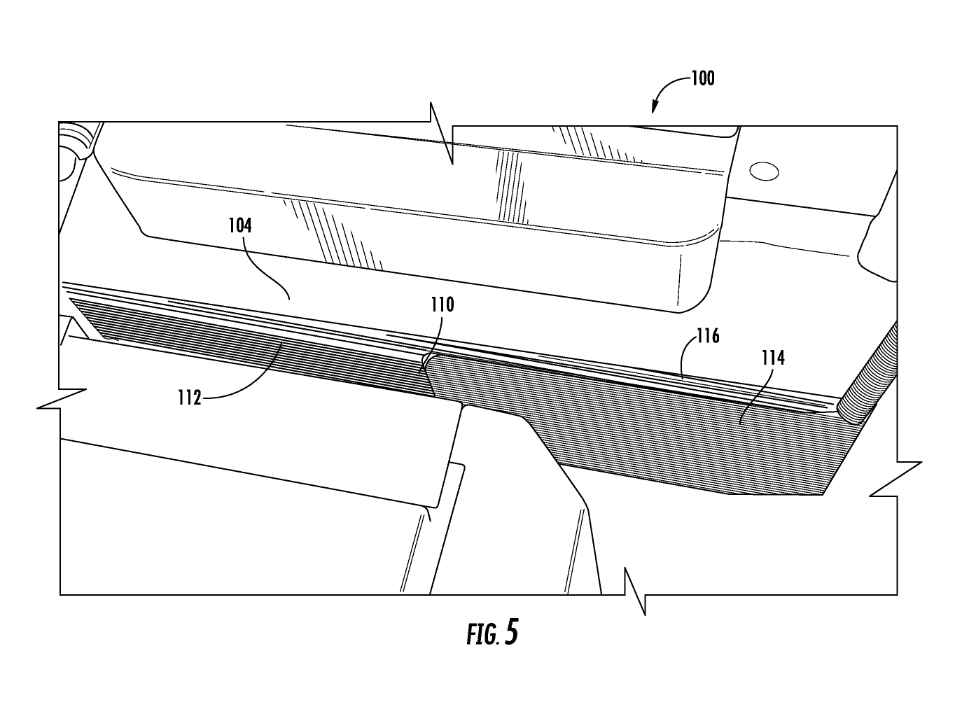

Once the first die 110 and the second die 104 are formed they can be assembled within the rolling apparatus 100 as illustrated by block 6 in FIG. 1. FIG. 5 illustrates the first die 110 as the stationary die 104 assembled within the rolling apparatus 100. In the illustrated embodiment of the invention, the first die 110 is assembled such that the coarse thread section 112 is operatively coupled to the fine thread section 114 to form the first die 110. The first die 110 is assembled in the rolling apparatus 100 such that the coarse threads would be formed first on a bolt 200 by the coarse thread section 112 of the first die 110, and thereafter, the fine threads would be formed on the bolt 200 by the fine thread section 114 of the first die 110. FIG. 6 illustrates the second die 130 as the moving die 106 assembled within the rolling apparatus 100. In the illustrated embodiment of the invention, the second die 130 is assembled such that when the moving die 106 is actuated it will form at least a part of the coarse threads 210 of the bolt 200 in conjunction with the coarse thread section 112 of the opposing first die 110 (e.g. stationary die 104), as well as support the bolt 200 in the proper position as the fine thread section 114 of the opposing first die 110 (e.g. stationary die) forms the fine threads 230 on the bolt 200.

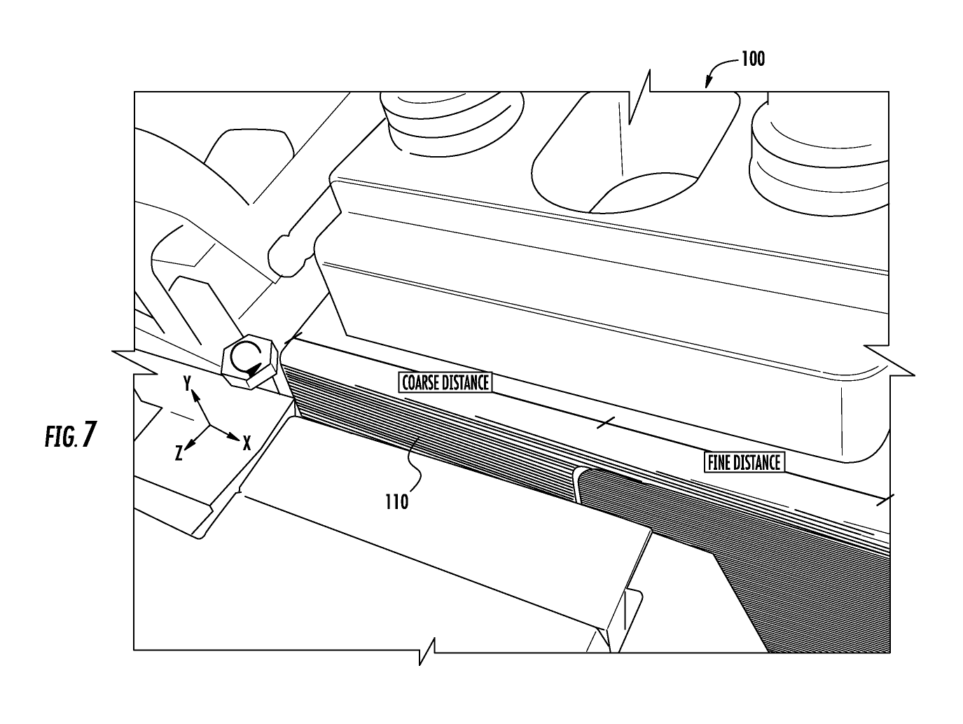

After the dies 102 are assembled into the rolling apparatus 100 the bolt shank 202 can be supported between the pair of dies 102, as illustrated by block 8 of the dual-threaded bolt manufacturing process 1 illustrated in FIG. 1. The bolt shank 202 is a cylindrical shank that has a smooth or generally smooth surface on which the dual-threads will be formed. As illustrated in FIG. 7, the bolt 200 is located between the dies 102 with its head located above (or outside) the dies, such that the head is not damaged during the rolling process. In other embodiments of the invention other types of parts, such as but not limited to, screws, dowel rods, bar stock, pins, anchor supports, etc. (which along with the bolt 200 can be cumulatively described as a “rod”) can be used to provide dual-threaded rods that could be used for various applications.

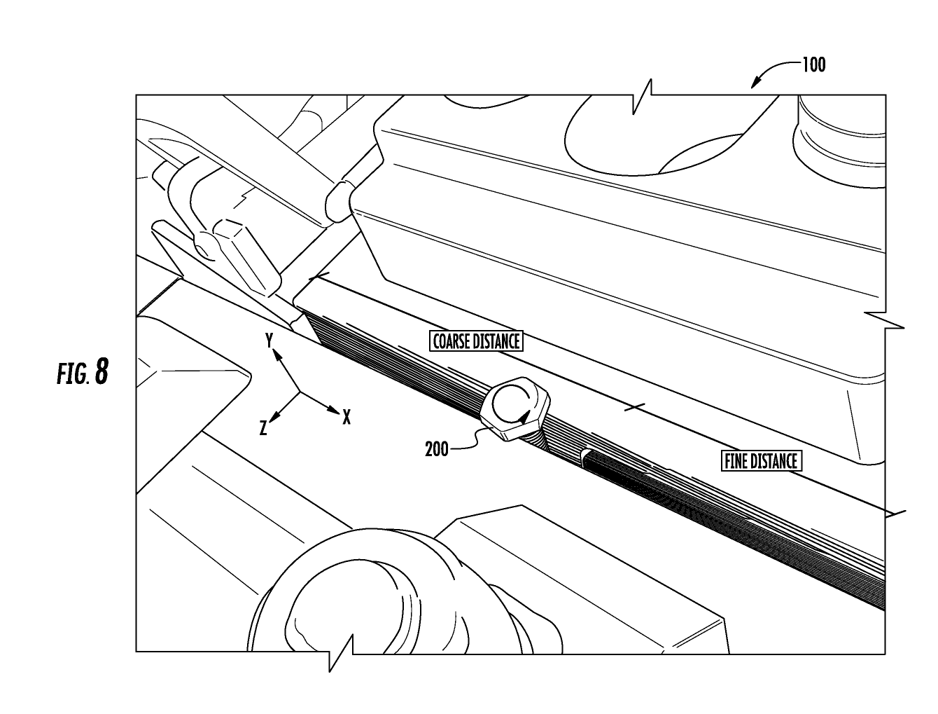

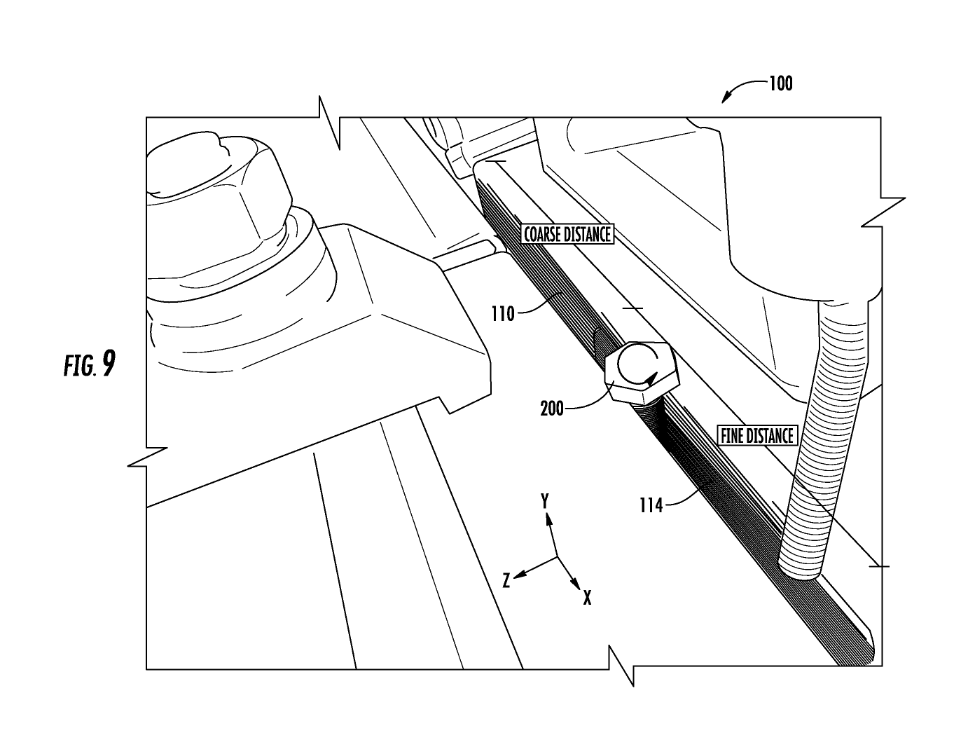

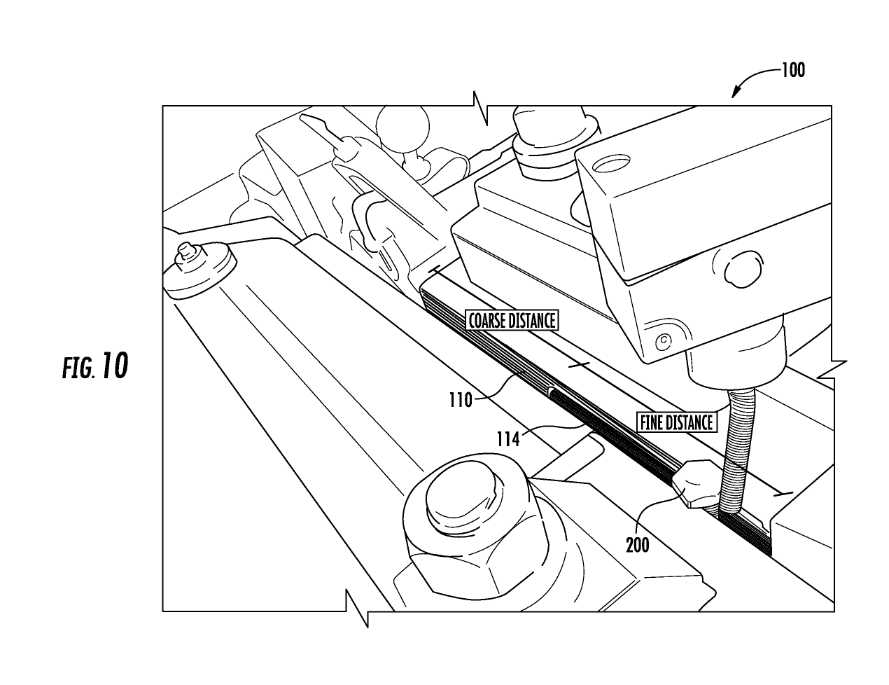

As illustrated by block 10 in FIG. 1, after the bolt 200 is secured in place the moving die 106 may be actuated in order to begin forming the coarse threads 210 of the dual-threaded bolt 200. As illustrated by FIG. 7, as the second die 130 (e.g. moving die 106) moves along the direction of the x-axis, the bolt 200 rotates in a counter-clockwise direction to form the coarse threads 210 of the dual-threaded bolt 200. As illustrated by block 12 in FIG. 1, the coarse threads 210 of the bolt 200 are formed first as the bolt 200 travels the length (e.g., coarse distance) of the coarse thread section 112 of the first die 110 (see FIGS. 7 and 8). As the bolt 200 travels the length of the coarse distance and reaches the fine thread section 114 the first die 110 begins to form the fine threads 230 on the bolt 200, as illustrated by block 14 of FIG. 1. The fine threads 230 are formed on the bolt 200 by the fine thread section 114 of the first die 110 as the bolt 200 travels the length of the fine distance (see FIGS. 9 and 10). In some embodiments, the coarse thread projections 142 across the face surface 140 of the second die 130 and the thread extending section 116 (e.g., leg) of the first die 110, are used to keep the bolt 200 in place as the fine threads 230 are formed on the bolt 200 by the fine thread section 114 of the first die 110.

FIG. 11 illustrates an example of the dual-threaded bolt 200 that can be formed using the dual-threaded manufacturing process 1 described herein. As illustrated, the dual-threaded bolt 200 has coarse threads 210 formed by the coarse thread projections 122, 142 of the first die 110 and the second die 130, respectively, and fine threads 220 formed by the fine thread projections 124 of the first die 110. The fine threads 230 are illustrated as being formed on the same location of the surface of every coarse thread 210, however, it is to be understood that the coarse threads 210 and fine threads 230 can be formed using various pitch ratios, phase shifts, etc., such that the fine threads 230 may not be formed on every coarse thread 210 and/or may be formed on different locations of the coarse threads 210. For example, the fine threads 230 may be formed on various surfaces of the coarse threads 210, such as but not limited to the first coarse thread surface 212, second coarse thread surface 214, coarse thread crest 216, etc.

In some embodiments, herein the dies, and movement thereof, have been described in an orientation from left to right. It should be understood that the dies, and movement therefor, could also be described in an orientation from right to left, in accordance with other embodiments of the invention, as well as in other orientations. The description of orientation is merely provided for the sake of illustrating one embodiment of the invention.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A method comprising:
forming a coarse thread over a first portion of a rod using a rolling apparatus in a single rolling pass;
forming a fine thread on the coarse thread over the first portion of the rod using the rolling apparatus in the single rolling pass; and
wherein the rolling apparatus comprises a first die with coarse thread projections and fine thread projections, and a second die with coarse thread projections.

2. The method of claim 1, wherein the first die comprises a coarse thread section with the coarse thread projections operatively coupled to a fine thread section with the fine thread projections

3. The method of claim 2, wherein the fine thread section is an insert and the coarse thread section is configured to be operatively coupled to the insert.

4. The method of claim 2, wherein the coarse thread section comprises an extending section, wherein the extending section forms a coarse thread over a second portion of the rod that does not have fine threads.

5. The method of claim 1, wherein the coarse thread projections and the fine thread projections of the first die are located on separate surfaces of a face of the first die.

6. The method of claim 1, wherein the rod is a bolt.

7. The method of claim 1, wherein the first die is a stationary die.

8. The method of claim 1, wherein the second die is a moveable die.

9. The method of claim 1, wherein forming the coarse thread and forming the fine thread in the single pass is accomplished by actuating the second die relative to the first die.

10. The method of claim 1, wherein at a transition from the coarse thread projections to the fine thread projections an edge of the coarse thread projections has integrally formed fine thread projections.

11. The method of claim 1, wherein at a transition from the coarse thread projections to the fine thread projections an edge of the fine thread projections has integrally formed coarse thread projections.

12. An apparatus comprising:
a first die with coarse thread projections and fine thread projections;
a second die with coarse thread projections;
wherein the first die and the second die are utilized for forming a coarse thread over a first portion of a rod in a single rolling pass; and
wherein the first die and the second die are utilized for forming a fine thread on the coarse thread over the first portion of the rod using the rolling apparatus in the single rolling pass;

13. The apparatus of claim 12, wherein the first die comprises a coarse thread section with the coarse thread projections operatively coupled to a fine thread section with the fine thread projections.

14. The apparatus of claim 13, wherein the fine thread section is an insert and the coarse thread section is configured to be operatively coupled to the insert.

15. The apparatus of claim 13, wherein the coarse thread section comprises an extending section, wherein the extending section forms a coarse thread over a second portion of the rod that does not have fine threads.

16. The apparatus of claim 12, wherein the coarse thread projections and the fine thread projections are located on separate surfaces of a face of the first die.

17. The apparatus of claim 12, wherein the rod is a bolt.

18. The apparatus of claim 12, wherein the first die is a stationary die.

19. The apparatus of claim 12, wherein the second die is a moveable die.

20. The apparatus of claim 12, wherein forming the coarse thread and forming the fine thread is accomplished by actuating the second die relative to the first die.

21. The apparatus of claim 12, wherein at a transition from the coarse thread projections to the fine thread projections an edge of the coarse thread projections has integrally formed fine thread projections.

22. The apparatus of claim 12, wherein at a transition from the coarse thread projections to the fine thread projections an edge of the fine thread projections has integrally formed coarse thread projections.
